(19) United States
(12) Patent Application Publication
(10) Pub. No.: US 2006/0080792 A1
(43) Pub. Date: Apr. 20, 2006

(54) Film-forming composition for the cosmetic treatment of keratin materials comprising at least one electrophilic monomer and at least one non-silicone polymer

(76) Inventors: Gabin Vic, Venette (FR); Gaelle Brun, Paris (FR); Aude Livoreil, Paris (FR); Luc Gourlaouen, Asnieres (FR); Franck Giroud, Clichy (FR); Isabelle Rollat-Corvol, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/248,336

(22) Filed: Oct. 13, 2005

Related U.S. Application Data
(60) Provisional application No. 60/645,600, filed on Jan. 24, 2005.

(30) Foreign Application Priority Data
Oct. 13, 2004 (FR) 0410805

(51) Int. Cl. A61Q 5/10

(52) U.S. Cl. 8/406

(57) ABSTRACT

Disclosd herein is a film-forming composition for the cosmetic treatment of keratin materials comprising, in a cosmetically acceptable medium, at least one electrophilic monomer and at least one non-silicone polymer, such that the film obtained from the composition by drying at room temperature and with a relative humidity level of about 50% has a Young's modulus of between 100 and 2000 MPa, measured for a thickness of 0.5 mm and with a tensile speed of 20 mm/min.

This application claims benefit of U.S. Provisional Application No. 60/645,600, filed Jan. 25, 2005, the contents of which are incorporated herein by reference. This application also claims benefit of priority under 35 U.S.C. § 119 to French Patent Application No. 0410805, filed Oct. 13, 2004, the contents of which are also incorporated herein by reference.

Disclosed herein is a film-forming composition for the cosmetic treatment of keratin materials comprising at least one electrophilic monomer and at least one non-silicone polymer. Also disclosed herein is a method for cosmetically treating keratin materials, comprising applying the film-forming composition to the keratin materials.

Within the field of cosmetology, attempts are made to modify the surface properties of keratin materials, such as keratin fibers, the hair for instance, in order to provide the keratin materials with a conditioning effect, such as softness, or sheen. This is generally done using cosmetic compositions based on conditioning agents such as silicones and polymers which have a high affinity for keratin materials, and especially for the hair.

However, the coating on keratin fibers, such as the hair, obtained with these compositions often has an unpleasant tacky feel and also the drawback of transferring, for example when a person passes a hand through the hair. This phenomenon of transfer leaves the appearance that the hair is dirty or tacky.

Moreover, these conditioning agents tend to be lost in the course of washing with shampoos, thus making it necessary to repeat application of the compositions to the hair.

In order to increase the staying power of polymer deposits, it is possible to carry out a free-radical polymerization of certain monomers directly on the hair. However, severe degradation of the hair fibers may be observed, probably associated with the polymerization initiators, and the hair thus treated can be difficult to disentangle.

The present inventors have found that by using the combination of at least one electrophilic monomer as described below with at least one specific non-silicone polymer, it is possible to overcome at least some of the drawbacks of the prior art and to obtain improved and/or durable conditioning of the hair.

The non-silicone polymer is chosen such that its combination with the at least one electrophilic monomer in a composition leads to the formation of a film, after drying of the composition at room temperature and at a relative humidity of about 50%, which has a Young's modulus ranging from 100 to 2000 MPa, measured for a thickness of 0.5 mm and with a tensile speed of 20 mm/min. This Young's modulus value range leads to the production of a rigid coat on the keratin materials.

The composition comprising such a combination makes it possible to maintain the softness and sheen provided to the hair by said composition, without repeat application, even after the hair has been washed a number of times. In addition, this composition, when applied to keratin materials, allows the keratin materials to be reinforced.

Applying a composition comprising such a combination leads to the in situ formation of a glossy, non-sticky coating which may have improved staying power, particularly in the face of washing. Furthermore, when it is applied to the hair, the composition may give the hair volume and hold, while the hairs remain individualized.

Thus, disclosed herein is a film-forming composition for the cosmetic treatment of keratin materials comprising, in a cosmetically acceptable medium, at least one electrophilic monomer and at least one non-silicone polymer as defined below. Also disclosed herein is a method for cosmetically treating keratin materials comprising applying the film-forming composition to the keratin materials. Further disclosed herein is a kit comprising a first composition comprising at least one electrophilic monomer and optionally at least one anionic and/or free-radical polymerization inhibitor, and a second composition comprising, in a cosmetically acceptable medium, at least one non-silicone polymer, for example, a non-silicone block copolymer.

Other subjects, features, aspects and advantages of the present disclosure will become clearer upon reading the description and examples which follow.

According to at least one embodiment of the present disclosure, the film-forming composition comprises, in a cosmetically acceptable medium, at least one electrophilic monomer and at least one non-silicone polymer such that the film obtained from the composition by drying at room temperature and with a relative humidity of about 50% has a Young's modulus ranging from 100 to 2000 MPa, measured for a thickness of 0.5 mm and with a tensile speed of 20 mm/min.

As used herein, the term “room temperature” means a temperature ranging from 20 to 24° C.

Non-Silicone Polymer

In at least one embodiment of the present disclosure, the at least one non-silicone polymer may comprise a main chain comprising carbon and hydrogen atoms, which may be optionally interrupted with at least one hetero atom chosen, for example, from O, N, P, and S, and which may optionally comprise at least one function chosen from chain-end functions and side functions.

The at least one non-silicone polymer used in accordance with the present disclosure may have a structure chosen from dendritic, linear, branched, random, comb, and star structures. It may also comprise at least one type of repeating unit, and may be a random, block, or alternating homopolymer or copolymer. In one embodiment, the at least one non-silicone polymer is chosen from block copolymers. The polymer may comprise at least five repeating units linked via covalent bonds.

As used herein, the term “non-silicone” means a polymer that does not contain an —Si—O—Si—linkage.

In at least one embodiment of the present disclosure, the homopolymers or copolymers that may be used in accordance with the present disclosure may dissolve or disperse spontaneously or by neutralization in water. They may comprise at least two blocks of hydrophilic nature of different chemical composition, or alternatively, at least one block of hydrophilic nature and at least one block of hydrophobic nature. They may be chosen from anionic, cationic, nonionic, and amphoteric polymers.

In another embodiment, the homopolymers or copolymers may dissolve or disperse spontaneously in an anhydrous medium. Such homopolymers or copolymers may comprise at least two blocks of hydrophobic nature of different chemical composition, or alternatively, at least one block of hydrophobic nature and at least one block of hydrophilic nature. They may be chosen from anionic, cationic, nonionic, and amphoteric polymers.

As used herein, the term “water-soluble, water-dispersible, or liposoluble homopolymer or copolymer” means a homopolymer or copolymer which, at a concentration of 0.1% by weight of active material in water or in an anhydrous solvent, at 25° C., leads, spontaneously, or after neutralization using an acid or a base, to a macroscopically homogeneous, transparent or translucent solution or suspension, i.e., a solution or suspension having a transmittance at a wavelength of 500 nm, through a sample 1 cm thick.

As used herein, the term “block of hydrophilic nature” means a block comprising at least 75 mol % of monomers that are water-soluble and/or water-dissolvable by neutralization. The block of hydrophilic nature comprises less than 25 mol %, for example, less than 10 mol %, or less than 5 mol % of water-insoluble monomers.

As used herein, the term “block of hydrophobic nature” means a block comprising at least 75 mol % of water-insoluble monomers. The block of hydrophobic nature comprises less than 25 mol %, for example, less than 10 mol %, or less than 5 mol % of water-soluble monomers.

Examples of monomers that may be used in the at least one non-silicone polymer of the present disclosure include, but are not limited to, those described in French Patent Application No. 2 840 205.

In at least one embodiment of the present disclosure, the at least one non-silicone polymer is chosen from amphiphilic linear block copolymers.

When the at least one non-silicone polymer is chosen from block copolymers, the water-soluble monomers forming the at least one hydrophilic block of the block copolymers may be chosen from anionic, nonionic, and cationic monomers and may be used alone or in the form of a mixture comprising at least two different monomers.

Examples of anionic water-soluble monomers include, but are not limited to, ethylenically unsaturated carboxylic acids, such as acrylic acid, methacrylic acid, itaconic acid, fumaric acid, crotonic acid, maleic acid, 2-acrylamido-2-methylpropanesulfonic acid, styrenesulfonic acid, vinylsulfonic acid, and vinylphosphonic acid.

Suitable nonionic water-soluble monomers include, for example, acrylamide, C₁-C₆ N-alkyl acrylamides, C₁-C₃ N,N-dialkyl acrylamides, polyethylene glycol acrylate, polyethylene glycol methacrylate, N-vinylacetamide, N-methyl-N-vinylacetamide, N-vinylformamide, N-methyl-N-vinylformamide, N-vinyllactams comprising a cyclic group comprising from 4 to 9 carbon atoms, vinyl alcohol (copolymerized in the form of vinyl acetate and then hydrolysed), ethylene oxide, hydroxyethyl acrylate, hydroxypropyl acrylate, hydroxyethyl methacrylate, and hydroxypropyl methacrylate.

Non-limiting examples of cationic water-soluble monomers include dimethyldiallylammonium chloride, methylvinylimidazolium chloride, 2-vinylpyridine, 4-vinylpyridine, 2-methyl-5-vinylpyridine, N-(C₁-C₄ alkyl)-4-vinylpyridinium halides such as N-methyl-4-vinylpyridinium iodide, vinylamine, the monomers of formula
H₂C═CX₁—CO—X₂
in which
   X₁ is chosen from hydrogen and methyl,
   X₂ is chosen from linear or branched C₁-C₆ hydrocarbon-based groups comprising at least one entity chosen from primary amine functions, secondary amine functions, tertiary amine functions, and quaternary nitrogen atoms, and groups of formula NHR₂ and NX₃X₄ in which X₃ and X₄ are, independently of each other, chosen from linear or branched C₁-C₆ hydrocarbon-based groups comprising at least one entity chosen from primary amine functions, secondary amine functions, tertiary amine functions, and quaternary nitrogen atoms.

When the at least one non-silicone polymer is chosen from block copolymers, the water-insoluble monomers forming the at least one hydrophobic block of the block copolymers may be chosen from vinylaromatic monomers such as styrene and alkyl derivatives thereof, for instance 4-butylstyrene, α-methylstyrene, and vinyltoluene; dienes such as butadiene and 1,3-hexadiene, and alkyl derivatives of dienes, such as isoprene and dimethylbutadiene; chloroprene; C₁-C₁₀ alkyl acrylates, C₆-C₁₀ aryl acrylates, C₆-C₁₀ aralkyl acrylates, C₁-C₁₀ alkyl methacrylates, C₆-C₁₀ aryl methacrylates, and C₆-C₁₀ aralkyl methacrylates, for instance, methyl, ethyl, n-butyl, 2-ethylhexyl, tert-butyl, isobornyl, phenyl, and benzyl (meth)arylate; vinyl acetate; vinyl ethers of formula CH₂═CH—O—R″ and allylic ethers of formula CH₂═CH—CH₂—O—R″, in which R″ is chosen from C₁-C₆ alkyl groups; acrylonitrile; vinyl chloride; vinylidene chloride; caprolactone; and ethylene, propylene, and vinyl monomers that are fluorinated or that comprise a perfluoro chain, such as fluoroalkyl acrylates, fluoroalkyl methacrylates, and alkyl α-fluoroalkylates.

The at least one non-silicone polymer may be present in the cosmetic composition in an amount ranging from 0.05% to 99% by weight, for example, from 0.1% to 95% by weight, or from 0.2% to 30% by weight relative to the total weight of the composition.

Electrophilic Monomer

As used herein, the term “electrophilic monomer” means a monomer capable of undergoing polymerization by anionic polymerization in the presence of a nucleophile such as, for example, the hydroxyl (OH—) ions present in water.

As used herein, the term “anionic polymerization” refers to the mechanism defined in March, Advanced Organic Chemistry, 3rd ed., pages 151 to 161.

The at least one electrophilic monomer may be chosen from from:

(i) benzylidenemalononitrile derivatives (A), 2-(4-chlorobenzylidene)malononitrile (A1), ethyl 2-cyano-3-phenylacrylate (B), and ethyl 2-cyano-3-(4-chlorophenyl) acrylate (B1), as described, for example, in Sayyah, J. Polymer Research, p. 97 (2000):

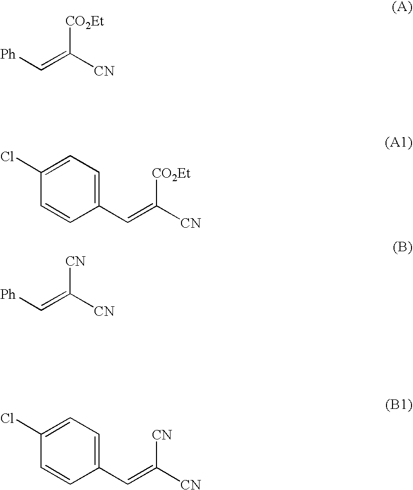

(ii) methylidenemalonate derivatives such as:
diethyl 2-methylenemalonate (C) as described, for example, in Hopff, Makromolekulare Chemie, p. 95 (1961), De Keyser, J. Pharm. Sci., p. 67 (1991), and Klemarczyk, Polymer, p. 173 (1998): 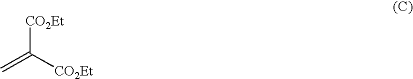
ethyl 2-ethoxycarbonylmethyleneoxycarbonylacrylate (D), as described, for example, by Breton, Biomaterials, p. 271 (1998) and Couvreur, Pharmaceutical Research p. 1270 (1994):

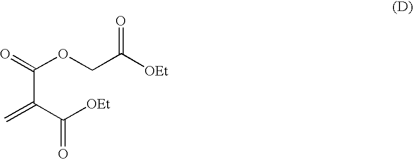

(iii) itaconate and itaconimide derivatives such as:
dimethyl itaconate (E), as described, for example, in Bachrach, European Polymer Journal, p. 563 (1976):

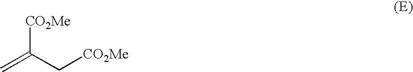

N-butylitaconimide (F), N-(4-tolyl)itaconimide (G), N-(2-ethyl-phenyl)itaconimide (H), and N-(2,6-diethylphenyl)itaconimide (I), as described, for example, in Wanatabe, J. Polymer Science: Part A: Polymer Chemistry p. 2073 (1994):

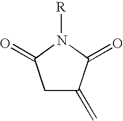

F): R=Bu; (G): R=4-tolyl; (H): R=2-ethylphenyl; (I): R=2,5-diethylphenyl

(iv) methyl α-(methylsulfonyl)acrylate derivatives (K), ethyl α-(methylsulfonyl)acrylate derivatives (L), methyl α-(tert-butylsulfonyl)acrylate derivatives (M), tert-butyl α-(methyl-sulfonyl)acrylate derivatives (N), and tert-butyl α-(tert-butylsulfonyl)acrylate derivatives (O), as described, for example, in Gipstein, J. Org. Chem, p. 1486 (1980), and 1,1-bis(methylsulfonyl)ethylene derivatives (P), 1-acetyl-1-methylsulfonylethylene derivatives (Q), methyl α-(methylsulfonyl)vinylsulfonate derivatives (R) and α-methylsulfonylacrylonitrile derivatives (S), as described, for example, in U.S. Pat. No. 2,748,050:

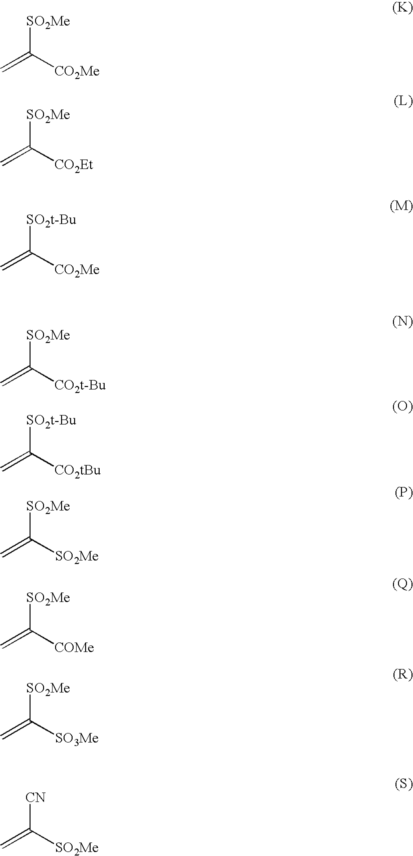

(v) methyl vinyl sulfone derivatives (T) and phenyl vinyl sulfone derivatives (U), as described, for example, in Boor, J. Polymer Science, p. 249 (1971):

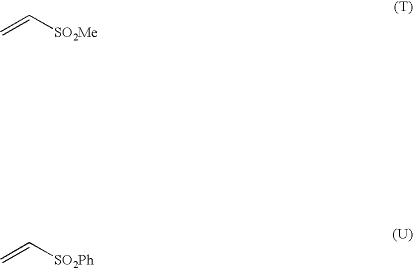

(vi) the phenyl vinyl sulfoxide derivative (V), as described, for example, in Kanga, Polymer Preprints (ACS, Division of Polymer Chemistry) p. 322 (1987):

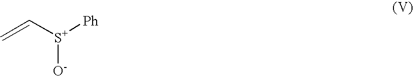

(vii) the 3-methyl-N-(phenylsulfonyl)-1-aza-1,3-butadiene derivative (W), as described, for example, in Bonner, Polymer Bulletin, p. 517 (1992):

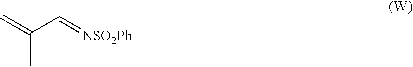

(viii) acrylate and acrylamide derivatives such as:
N-propyl-N-(3-triisopropoxysilylpropyl)acrylamide (X) and N-propyl-N-(3-triethoxysilylpropyl)acrylamide (Y), as described, for example, in Kobayashi, Journal of Polymer Science, Part A: Polymer Chemistry, p. 2754 (2005): 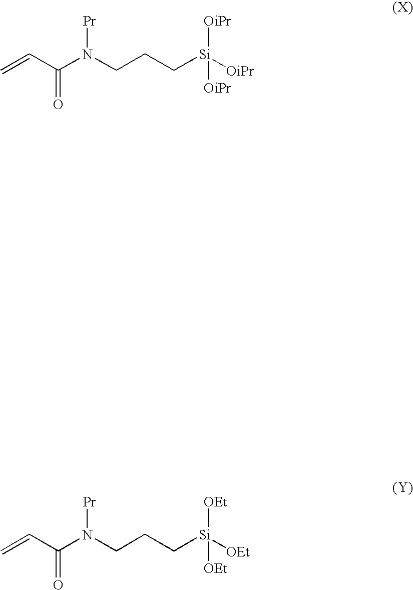
2-hydroxyethyl acrylate (Z) and 2-hydroxyethyl methacrylate (AA), as described, for example, in Rozenberg, International Journal of Plastics Technology, p. 17 (2003): 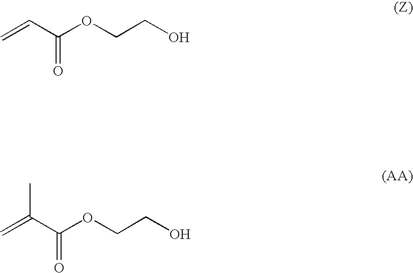
n-butyl acrylate (AB), as described, for example, in Schmitt, Macromolecules, p. 2115 (2001) and tert-butyl acrylate (AC), as described, for example, in Ishizone, Macromolecules, p. 955 (1999):

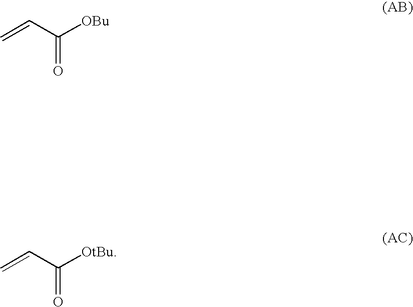

The at least one electrophilic (or electron-withdrawing) monomer may be cyclic or linear. In one embodiment, when the monomer is cyclic, the electron-withdrawing group may be exocyclic, i.e., it does not form an integral part of the cyclic structure of the monomer.

According to at least one embodiment of the present disclosure, the at least one electrophilic monomer may comprise at least two electron-withdrawing groups.

Examples of electrophilic monomers having at least two electron-withdrawing groups include, but are not limited to, the monomers of formula (I): 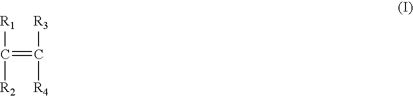
in which:
R₁ and R₂, are, independently of one another, minimally or non-electron-withdrawing groups (having little or no inductive withdrawal effect), such as:
   hydrogen,
   saturated or unsaturated, linear, branched, or cyclic hydrocarbon-based groups, comprising, for example, from 1 to 20, or from 1 to 10, carbon atoms, and optionally comprising at least one atom chosen from nitrogen, oxygen, and/or sulfur, and optionally substituted with at least one group chosen from —OR, —COOR, —COR, —SH, —SR, —OH, and halogen atoms,
   modified or non-modified polyorganosiloxane residues, and
   polyoxyalkylene groups,
R₃ and R₄, are, independently of one another, electron-withdrawing (or inductively withdrawing) groups chosen, for example, from —N(R)₃⁺, —S(R)₂⁺, —SH₂⁺, —NH₃⁺, —NO₂, —SO₂R, —C≡N, —COOH, —COOR, —COSR, —CONH₂, —CONHR, —F, —Cl, —Br, —I, —OR, —COR, —SH, —SR, and —OH groups, linear or branched alkenyl groups, linear or branched alkynyl groups, C₁-C₄ mono- or polyfluoroalkyl groups, aryl groups such as phenyl, and aryloxy groups such as phenyloxy,

R is chosen from saturated or unsaturated linear, branched, or cyclic hydrocarbon-based groups comprising, for example, from 1 to 20, or from 1 to 10, carbon atoms, and optionally comprising at least one atom chosen from nitrogen, oxygen, and/or sulfur, and optionally substituted with at least one group chosen from —OR′, —COOR′, —COR′, —SH, —SR′, —OH, halogen atoms, and polymer residues obtainable by free-radical polymerization, polycondensation, or ring opening, and

R′ is chosen from C₁-C₁₀ alkyl groups.

As used herein, the term “electron-withdrawing or inductively withdrawing group (—I)” means any group which is more electronegative than carbon. Reference may be made to P. R. Wells, Prog. Phys. Org. Chem., vol. 6, page 111 (1968).

As used herein, the term “minimally or non-electron-withdrawing group” means any group whose electronegativity is less than or equal to that of carbon.

In at least one embodiment of the present disclosure, the alkenyl and/or alkynyl groups of R₃ and R₄ of formula (I) may comprise from 2 to 20 carbon atoms, for example, from 2 to 10 carbon atoms.

Non-limiting examples of saturated or unsaturated linear, branched, or cyclic hydrocarbon-based groups comprising from 1 to 20 carbon atoms, or from 1 to 10 carbon atoms, include, for example, linear or branched alkyl groups, linear or branched alkenyl groups, and linear or branched alkynyl groups, such as methyl, ethyl, n-butyl, tert-butyl, isobutyl, pentyl, hexyl, octyl, butenyl, and butynyl groups; cycloalkyl groups; and aromatic groups.

Examples of substituted hydrocarbon-based groups include, for example, hydroxyalkyl and polyhaloalkyl groups.

Examples of non-modified polyorganosiloxanes include, but are not limited to, polyalkylsiloxanes such as polydimethylsiloxanes, polyarylsiloxanes such as polyphenylsiloxanes, and polyarylalkylsiloxanes such as polymethylphenylsiloxanes.

Suitable modified polyorganosiloxanes, include, for example, polydimethylsiloxanes comprising polyoxyalkylene, siloxy, silanol, amine, imine, and/or fluoroalkyl groups.

Non-limiting examples of polyoxyalkylene groups include polyoxyethylene groups and polyoxypropylene groups comprising, for example, from 1 to 200 oxyalkylene units.

Examples of mono- or polyfluoroalkyl groups include, for example, groups such as —(CH₂)ₙ—(CF₂)ₘ—CF₃ and —(CH₂)ₙ—(CF₂)ₘ—CHF₂, wherein n is a number ranging from 1 to 20 and m is a number ranging from 1 to 20.

In accordance with at least one embodiment of the present disclosure, the substituents R₁ to R₄ may optionally be substituted with at least one group having cosmetic activity. Cosmetic activities may be obtained from groups comprising at least one coloring, antioxidant, UV filter, and/or conditioning function.

Groups comprising a coloring function include, but are not limited to, azo, quinone, methine, cyanomethine, and triarylmethane groups.

Examples of groups comprising an antioxidant function include, for example, butylated hydroxyanisole (BHA), butylated hydroxytoluene (BHT), and vitamin E groups.

Non-limiting examples of groups comprising a UV filter function include benzophenone, cinnamate, benzoate, benzylidenecamphor, and dibenzoylmethane groups.

Suitable groups comprising a conditioning function include, for example, cationic groups and groups of fatty ester type.

According to at least one embodiment of the present disclosure, the at least one electrophilic monomer may be chosen from the monomers from cyanoacrylates and their derivatives, of formula (II): 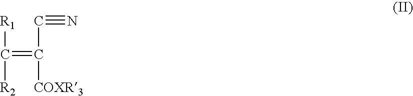
wherein:
X is chosen from NH, S, and O,
R₁ and R₂, are, independently of one another, minimally or non-electron-withdrawing groups (minimally or non-inductively-withdrawing groups) such as:
   hydrogen,
   saturated or unsaturated, linear, branched, or cyclic hydrocarbon-based groups comprising, for example, from 1 to 20, or from 1 to 10 carbon atoms and optionally comprising at least one atom chosen from nitrogen, oxygen, and sulphur, and optionally substituted with at least one group chosen from —OR, —COOR, —COR, —SH, —SR, —OH, and halogen atoms, modified or unmodified polyorganosiloxane residues, and
   polyoxyalkylene groups;
R′₃ is chosen from hydrogen and the radical R;
R is chosen from saturated or unsaturated linear, branched, or cyclic hydrocarbon-based groups comprising, for example, from 1 to 20, or from 1 to 10 carbon atoms, and optionally comprising at least one atom chosen from nitrogen, oxygen, and sulphur, and optionally substituted by at least one group chosen from —OR′, —COOR′, —COR′, —SH, —SR′, and —OH, halogen atoms, and polymer residues obtainable by free-radical polymerization, condensation, or ring opening; and
R′ is chosen from C₁-C₁₀ alkyl radicals.

In at least one embodiment, X may be 0.

Compounds of formula (II) may include, for example:

a) belonging to the class of C₁₋₂₀ polyfluoroalkyl 2-cyanoacrylates, such as: the 2,2,3,3-tetrafluoropropyl ester of 2-cyano-2-propenoic acid, of formula (III): 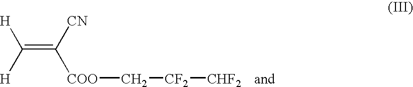
the 2,2,2-trifluoroethyl ester of 2-cyano-2-propenoic acid, of formula (IV): 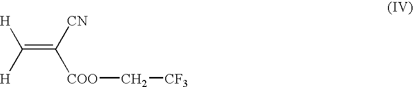
b) C₁-C₁₀ alkyl and (C₁-C₄)alkoxy(C₁-C₁₀)alkyl cyanoacrylates.

In at least one embodiment of the present disclosure, the at least one electrophilic monomer may be chosen, for example, from ethyl 2-cyanoacrylate, methyl 2-cyanoacrylate, n-propyl 2-cyanoacrylate, isopropyl 2-cyanoacrylate, tert-butyl 2-cyanoacrylate, n-butyl 2-cyanoacrylate, isobutyl 2-cyanoacrylate, 3-methoxybutyl cyanoacrylate, n-decyl cyanoacrylate, hexyl 2-cyanoacrylate, 2-ethoxyethyl 2-cyano-acrylate, 2-methoxyethyl 2-cyanoacrylate, 2-octyl 2-cyanoacrylate, 2-propoxyethyl 2-cyano-acrylate, n-octyl 2-cyanoacrylate, and isoamyl cyanoacrylate.

In another embodiment, the at least one electrophilic monomer may be chosen from C₁-C₁₀ alkyl and (C₁-C₄)alkoxy(C₁-C₁₀)alkyl cyanoacrylates.

In a further embodiment, the at least one electrophilic monomer may be chosen from monomers of formula (V) and mixtures thereof: 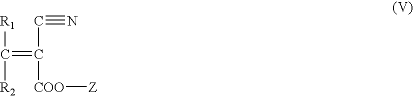
in which Z is chosen from:
   —(CH₂)₇—CH₃;
   —CH(CH₃)—(CH₂)₅—CH₃;
   —CH₂—CH(C₂H₅);
   —(CH₂)₃—CH₃;
   —(CH₂)₅—CH(CH₃)—CH₃; and
   —(CH₂)₄—CH(C₂H₅)—CH₃.

The at least one electrophilic monomer used in accordance with the present disclosure may be attached covalently to at least one support such as polymers, oligomers, and dendrimers. The polymer or oligomer may have a structure chosen from linear, branched, comb, and block structures. The distribution of the monomers of the invention over the polymeric, oligomeric, or dendritic structure may be chosen from random, terminal, and blockwise distributions.

According to at least one embodiment of the present disclosure, the at least one electrophilic monomer may be chosen from monomers capable of undergoing polymerization on keratin fibers under cosmetically acceptable conditions. In one embodiment, the polymerization of the monomer may take place at a temperature less than or equal to 80° C., for example, at a temperature ranging from 10 to 80° C., or from 20 to 80° C., which does not prevent the application from being completed with an operation involving heat, for example, drying under a hood, blow-drying, and/or passage of a flat iron and/or curling tongs over the keratin fibers.

The at least one electrophilic monomer may be present in the composition in an amount ranging from 0.001% to 80% by weight, for example, from 0.1% to 40%, or from 1% to 20% by weight relative to the total weight of the composition.

Cosmetically Acceptable Medium

As used herein, the term “cosmetically acceptable medium” means a medium which is compatible with keratin materials such as the hair.

In accordance with at least one embodiment of the present disclosure, the cosmetically acceptable medium may be anhydrous. As used herein, the term “anhydrous medium” means a medium comprising less than 1% by weight of water relative to the total weight of the composition.

The cosmetically acceptable may be chosen from organic oils; silicones such as volatile silicones, amino or non-amino silicone gums and oils, and mixtures thereof; mineral oils; vegetable oils such as olive oil, castor oil, colza oil, copra oil, wheatgerm oil, sweet almond oil, avocado oil, macadamia oil, apricot oil, safflower oil, candlenut oil, false flax oil, tamanu oil, and lemon oil; waxes; organic compounds such as C₅-C₁₀ alkanes; acetone; methyl ethyl ketone; esters of C₁-C₂₀ acids and C₁-C₈ alcohols such as methyl acetate, butyl acetate, ethyl acetate, and isopropyl myristate; dimethoxyethane; diethoxyethane; C₁₀-C₃₀ fatty alcohols such as lauryl alcohol, cetyl alcohol, stearyl alcohol, and behenyl alcohol; C₁₀-C₃₀ fatty acids such as lauric acid and stearic acid; C₁₀-C₃₀ fatty amides such as lauric diethanolamide; C₁₀-C₃₀ fatty alcohol esters such as C₁₀-C₃₀ fatty alcohol benzoates, and mixtures thereof.

In one embodiment, the organic compounds may be selected from compounds which are liquid at a temperature of 25° C. and under 105 Pa (760 mmHg).

Optional Additives

The film-forming composition according to the present disclosure may further comprise at least one polymerization inhibitor, chosen for example, from free-radical and/or anionic polymerization inhibitors, in order to increase the stability of the composition over time. Examples of suitable polymerization inhibitors include, but are not limited to, sulfur dioxide, nitric oxide, lactone, boron trifluoride, hydroquinone and its derivatives such as hydroquinone monoethyl ether, tert-butylhydroquinone (TBHQ), benzoquinone and its derivatives such as duroquinone, catechol and its derivatives such as tert-butylcatechol and methoxycatechol, anisole and its derivatives such as methoxyanisole, hydroxyanisole or butylated hydroxyanisole, pyrogallol, 2,4-dinitrophenol, 2,4,6-trihydroxybenzene, p-methoxyphenol, hydroxybutyltoluene, alkyl sulfates, alkyl sulfites, alkyl sulfones, alkyl sulfoxides, alkyl sulfides, mercaptans, 3-sulfolene, and mixtures thereof. The alkyl groups may be chosen from groups comprising from 1 to 6 carbon atoms.

Further examples of polymerization inhibitors include, for example, organic and inorganic acids, such as organic acids having at least one group chosen from carboxylic and sulfonic groups, which have a pKa ranging from 0 to 6, for instance, phosphoric acid, hydrochloric acid, nitric acid, benzene-sulfonic acid, toluene-sulfonic acid, sulfuric acid, carbonic acid, hydrofluoric acid, acetic acid, formic acid, propionic acid, benzoic acid, mono-, di-, or trichloroacetic acids, salicylic acid, and trifluoroacetic acid.

The at least one polymerization inhibitor may be present in the composition in amounts ranging from 10 ppm to 20%, for example, from 10 ppm to 5%, or from 10 ppm to 1% by weight relative to the total weight of the composition.

The composition in accordance with the present disclosure may further comprise at least one additional agent which is commonly used in cosmetic compositions, for example, reducing agents, fats, plasticizers, softeners, antifoams, moisturizers, pigments, clays, mineral fillers, UV filters, mineral colloids, peptizers, solubilizers, perfumes, preservatives, anionic surfactants, cationic surfactants, nonionic surfactants, amphoteric surfactants, fixative polymers, non-fixative polymers, polyols, proteins, vitamins, direct dyes, oxidation dyes, pearlizers, propellant gases, and organic or inorganic thickeners such as benzylidenesorbitol and N-acylamino acids.

The additional agents may be optionally encapsulated, for example, in a polycyanoacrylate capsule.

Cosmetic Treatment Method

Disclosed herein is a method for cosmetically treating keratin materials such as the hair, comprising applying a film-forming composition to the keratin materials, in the presence of a nucleophile.

The at least one nucleophile capable of initiating the anionic polymerization may include systems known in the art which are capable of generating a carbanion upon contact with an electrophilic monomer. As used herein, the term “carbanion” refers to the chemical species defined, for example, in March, Advanced Organic Chemistry, 3rd ed., page 141.

The at least one nucleophile may be chosen from molecular compounds, oligomers, dendrimers, and polymers which comprise at least one nucleophilic function, for example, R₂N⁻, NH₂⁻, Ph₃C⁻, R₃C⁻, PhNH⁻, pyridine, ArS⁻, R—C≡C⁻, RS⁻, SH⁻, RO⁻, R₂NH, ArO⁻, N₃⁻, OH⁻, ArNH₂, NH₃, I⁻, Br⁻, Cl⁻, RCOO⁻, SCN⁻, ROH, RSH, NCO⁻, CN⁻, NO3⁻, ClO₄⁻ and H₂O, wherein Ph is a phenyl group, Ar is chosen from aryl groups, and R is chosen from C₁-C₁₀ alkyl groups.

In at least one embodiment, the nucleophiles may be hydroxyl ions, such as those present in water. Water may be provided, for example, by pre-wetting the keratin materials before application of the film-forming composition.

Also disclosed herein is a method for cosmetically treating keratin materials, comprising at least two steps, the first step comprising applying a first composition comprising at least one non-silicone polymer, and the second step comprising applying a second composition comprising at least one electrophilic monomer, the order of the steps being arbitrary.

In one embodiment, the at least one non-silicone polymer may be applied to the keratin materials before the at least one electrophilic monomer.

In another embodiment, the first composition comprising the electrophilic monomer does not contain any nucleophile. In yet another embodiment, the second composition may comprise the at least one nucleophile, and is used just before or after the first composition.

In order to modify the reaction kinetics, the keratin materials, for example, keratin fibers, may be wet beforehand by means of an aqueous solution whose pH has been adjusted using a base, an acid, or an acid/base mixture. The acid and/or the base may be organic or inorganic.

It is also possible to modify the anionic polymerization kinetics by pre-impregnating the keratin materials, and especially the keratin fibers, using a nucleophile other than water. The at least one nucleophile may be pure, in solution or in the form of an emulsion, or may be encapsulated.

In order to modify the anionic polymerization kinetics, the nucleophilicity of the keratin materials, for example, keratin fibers, may be enhanced by chemically converting the keratin material.

A non-limiting example of a chemical conversion is the reduction of the disulfide bridges, of which the keratin is partly composed, to thiols, prior to application of the film-forming composition of the invention. Examples of reducing agents include, but are not limited to:
anhydrous sodium thiosulfate,
powdered sodium metabisulfite,
thiourea,
ammonium sulfite,
thioglycolic acid,
thiolactic acid,
ammonium thiolactate,
glycerol monothioglycolate,
ammonium thioglycolate,
thioglycerol,
2,5-dihydroxybenzoic acid,
diammonium dithioglycolate,
strontium thioglycolate,
calcium thioglycolate,
zinc formaldehyde-sulfoxylate,
isooctyl thioglycolate,
dl-cysteine, and
monoethanolamine thioglycolate.

In order to modify the anionic polymerization kinetics, for example, to reduce the polymerization rate of the at least one electrophilic monomer, the viscosity of the composition may be enchanced by adding to the composition at least one thickening polymer which exhibits no reactivity with the at least one electrophilic monomer. Examples of suitable polymers include, but are not limited to, poly(methyl methacrylate) (PMMA) and cyanoacrylate-based copolymers described, for example, in U.S. Pat. No. 6,224,622.

In order to improve, among other things, the adhesion of the poly(cyanoacrylate) formed in situ, the keratin materials may be pretreated with polymers of any type. Optionally, a hair treatment may be performed before applying the film-forming composition of the invention, such as a direct dyeing, oxidation dyeing, permanent waving, and/or a straightening operation.

The application of the film-forming composition to the keratin materials may or may not be followed by rinsing.

The film-forming compositions may be in a form chosen from lotions, sprays, and foams, and may be applied as a shampoo or conditioner.

Also disclosed herein is a film-forming composition comprising, in a cosmetically acceptable medium, at least one electrophilic monomer and at least one non-silicone block copolymer as described above. For the purposes of the present invention, the term “block copolymer” means any copolymer comprising at least two different blocks. In one embodiment, the block polymers of the invention may be linear.

Further disclosed herein is a kit comprising a first composition comprising at least one electrophilic monomer and optionally at least one free-radical and/or anionic polymerization inhibitor, and a second composition comprising, in a cosmetically acceptable medium, at least one non-silicone polymer, for example, a non-silicone block copolymer.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, unless otherwise indicated the numerical values set forth in the specific examples are reported as precisely as possible. Any numerical value, however, inherently contain certain errors necessarily resulting from the standard deviation found in their respective testing measurements.

By way of non-limiting illustration, concrete examples of certain embodiments of the present disclosure are given below. In the examples below, all amounts are indicated in percent by weight of active substance relative to the total weight of the composition, unless indicated otherwise.

### EXAMPLES

### Example 1

The following composition was prepared, in accordance with the invention:

| | |
|---|---|
| 2-Octyl cyanoacrylate¹ | 49% |
| Poly(methyl methacrylate)² | 50% |
| Monoethanolamine | 1% |

¹sold by Chemence
²polymethyl methacrylate beads, Acros Chemical, reference 178765000

The composition thus-prepared was deposited onto a Teflon matrix. The film was dried at room temperature and under a relative humidity of 50%. The thickness of the film obtained was 0.5 mm.

The Young's modulus of the film obtained was measured with a Lloyd model RLSK machine for a tensile speed of 20 mm/min. The value obtained was about 200 MPa.

The composition was applied to the hair and dried, giving a shampoo-resistant rigid coat.

### Example 2

This example demonstrates the rigid nature of the coat obtained using the compositions according to the invention.

The following compositions were prepared, in accordance with the invention.

Composition A: Methylheptyl Cyanoacrylate Monomer and Oily Silicone Medium and PVP Polymer

Composition A1:

| | |
|---|---|
| Polyvinylpyrrolidone Luviskol from BASF | 5% |
| Water | qs 100 |

Composition A2:

| | |
|---|---|
| Methylheptyl cyanoacrylate¹ | 10% |
| DC245 Fluid from Dow Corning | 45% |
| DC 1501 Fluid from Dow Corning | 45% |

¹sold by Chemence

Composition A1 was applied to clean, wet hair. Composition A2 was subsequently applied to the hair. The hair was dried for 30 minutes under a drying hood.

Composition B: Methylheptyl Cyanoacrylate Monomer and Oily Silicone Medium and Polymer PS

Composition B1:

| | |
|---|---|
| Polystyrene dispersion Modarez OS-197 from | 5% |
| Synthron | |
| Water | qs 100 |

Composition B2:

| | |
|---|---|
| Methylheptyl cyanoacrylate¹ | 10% |
| DC245 Fluid from Dow Corning | 45% |
| DC 1501 Fluid from Dow Corning | 45% |

¹sold by Chemence

Composition B1 was applied to clean, wet hair. Composition B2 was subsequently applied to the hair. The hair was then dried for 30 minutes under a drying hood.

Composition C: Methylheptyl Cyanoacrylate Monomer and Silicone Oily Medium and PMMA Polymer

Composition C1:

| | |
|---|---|
| Polymethyl methacrylate from Acros, | 5% |
| reference 178765000 | |
| Methyl ethyl ketone | qs 100 |

Composition C2:

| | |
|---|---|
| Methylheptyl cyanoacrylate¹ | 10% |
| DC245 Fluid from Dow Corning | 45% |
| DC 1501 Fluid from Dow Corning | 45% |

¹sold by Chemence

Composition C1 was applied to clean, wet hair. Composition C2 was subsequently applied to the hair. The hair was dried for 30 minutes under a drying hood.

A measurement of the Young's modulus of the coat formed directly on the hair after applying compositions A, B, and C above was performed by means of nanoindentation by atomic force microscopy (AFM).

The results obtained were as follows:

| | Young's modulus |
|---|---|
| Composition A | 428 MPa (+/− 227) |
| Composition B | 360 MPa (+/− 119) |
| Composition C | 236 MPa (+/− 105) |

The Young's modulus values obtained were all greater than 100 MPa, indicating the formation of rigid coats.

### Examples 3 to 9

Examples 3 to 9 below illustrate other compositions in accordance with the invention. The following compositions wer prepared, in accordance with the invention.

### Example 3

| | |
|---|---|
| Methylheptyl cyanoacrylate¹ | 10% |
| DC245 Fluid from Dow Corning | 25% |
| DC 1501 Fluid from Dow Corning | 25% |
| Poly(methyl methacrylate) | 39% |
| Monoethanolamine | 1% |

¹sold by Chemence

### Example 4

| | |
|---|---|
| Methylheptyl cyanoacrylate¹ | 10% |
| Pure olive oil from Arista Industries | 50% |
| Poly(methyl methacrylate) | 39% |
| Monoethanolamine | 1% |

¹sold by Chemence

### Example 5

| | |
|---|---|
| Ethoxyethyl cyanoacrylate¹ | 49% |
| Poly(methyl methacrylate) | 50% |
| Monoethanolamine | 1% |

¹EO 460 sold by Tong Shen

### Example 6

| | |
|---|---|
| Butyl cyanoacrylate¹ | 49% |
| Poly(methyl methacrylate) | 50% |
| Monoethanolamine | 1% |

¹B-60 sold by Tong Shen

### Example 7

| | |
|---|---|
| Ethylhexyl cyanoacrylate¹ | 49% |
| Poly(methyl methacrylate) | 50% |
| Monoethanolamine | 1% |

¹O-60 sold by Tong Shen

### Example 8

| | |
|---|---|
| Methylheptyl cyanoacrylate¹ | 44.1% |
| Ethylhexyl cyanoacrylate² | 4.9% |
| Poly(methyl methacrylate) | 50% |
| Monoethanolamine | 1% |

¹sold by Chemence
²O-60 sold by Tong Shen

### Example 9

| | |
|---|---|
| Methylheptyl cyanoacrylate¹ | 34.3% |
| Butyl cyanoacrylate² | 14.7% |
| Poly(methyl methacrylate) | 50% |
| Monoethanolamine | 1% |

¹sold by Chemence
²B-60 sold by Tong Shen

What is claimed is:

1. A method for the cosmetic treatment of keratin materials comprising, applying to said keratin materials a film-forming composition comprising, in a cosmetically acceptable medium, at least one electrophilic monomer and at least one non-silicone polymer chosen such that the film obtained when the composition is dried at room temperature and with a relative humidity level of about 50% has a Young's modulus ranging from 100 to 2000 MPa, measured for a thickness of 0.5 mm and with a tensile speed of 20 mm/min.

2. The method of claim 1, wherein the at least one non-silicone polymer is chosen from homopolymers and random, block, and alternating copolymers.

3. The method of claim 2, wherein the at least one non-silicone polymer is chosen from block copolymers.

4. The method of claim 2, wherein the at least one non-silicone polymer is chosen from linear block amphiphilic copolymers.

5. The method of claim 4, wherein the linear block amphiphilic copolymers comprise water-soluble monomers of anionic, nonionic, and/or cationic nature.

6. The method of claim 4, wherein linear block amphiphilic copolymers comprise water-insoluble monomers chosen from vinylaromatic monomers, dienes and alkyl derivatives of dienes, chloroprene, C₁-C₁₀ alkyl acrylates, C₆-C₁₀ aryl acrylates, C₆-C₁₀ aralkyl acrylates, C₁-C₁₀ alkyl methacrylates, C₆-C₁₀ aryl methacrylates, C₆-C₁₀ aralkyl methacrylates, vinyl acetate, vinyl ethers of formula CH₂═CH—O—R″ and allylic ethers of formula CH₂═CH—CH₂—O—R″ in which R″ is chosen from C₁-C₆ alkyl groups, acrylonitrile, vinyl chloride, vinylidene chloride, caprolactone, ethylene, propylene, and vinyl monomers that are fluorinated or that comprise a perfluoro chain.

7. The method of claim 1, wherein the at least one non-silicone polymer is present in the composition in an amount ranging from 0.05% to 99% by weight relative to the total weight of the composition.

8. The method of claim 7, wherein the at least one non-silicone polymer is present in the composition in an amount ranging from 0.1% to 95% by weight relative to the total weight of the composition.

9. The method of claim 1, wherein the at least one electrophilic monomer is chosen from monomers of formula (I): 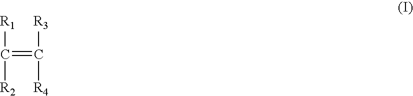
in which:
R₁ and R₂, are, independently of one another, chosen from minimally or non-electron-withdrawing groups chosen from:
hydrogen,
saturated or unsaturated, linear, branched, or cyclic hydrocarbon-based groups comprising from 1 to 20 carbon atoms and optionally comprising at least one atom chosen from nitrogen, oxygen, and/or sulfur, and optionally substituted at least one group chosen from —OR, —COOR, —COR, —SH, —SR, —OH, and halogen atoms,
modified or unmodified polyorganosiloxane residues, and
polyoxyalkylene groups,
R₃ and R₄, are, independently of one another, electron-withdrawing groups chosen from —N(R)₃⁺, —S(R)₂⁺, —SH₂⁺, —NH₃⁺, —NO₂, —SO₂R, —C—N, —COOH, —COOR, —COSR, —CONH₂, —CONHR, —F, —Cl, —Br, —I, —OR, —COR, —SH, —SR, and —OH groups, linear or branched alkenyl groups, linear or branched alkynyl groups, C₁-C₄ mono- or polyfluoroalkyl groups, aryl groups, and aryloxy groups,
R is chosen from saturated or unsaturated linear, branched or cyclic hydrocarbon-based groups comprising from 1 to 20 carbon atoms and optionally comprising one or more atoms chosen from nitrogen, oxygen, and/or sulfur, and optionally substituted with at least one group chosen from —OR′, —COOR′, —COR′, —SH, —SR′, —OH, halogen atoms, and polymer residues obtainable by free-radical polymerization, polycondensation, or ring opening, and
R′ is chosen from C₁-C₁₀ alkyl groups.

10. The method of claim 9, wherein the at least one electrophilic monomer is chosen from compounds of formula (II): 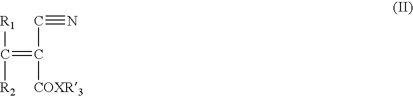
wherein:
X is chosen from NH, S, and O,
R₁₃ is chosen from hydrogen and the radical R,
R₁ and R₂, are, independently of one another, chosen from minimally or non-electron-withdrawing groups chosen from:
hydrogen,
saturated or unsaturated, linear, branched, or cyclic hydrocarbon-based groups comprising from 1 to 20 carbon atoms and optionally comprising at least one atom chosen from nitrogen, oxygen, and/or sulfur, and optionally substituted at least one group chosen from —OR, —COOR, —COR, —SH, —SR, —OH, and halogen atoms,
modified or unmodified polyorganosiloxane residues, and polyoxyalkylene groups,
R is chosen from saturated or unsaturated linear, branched or cyclic hydrocarbon-based groups comprising from 1 to 20 carbon atoms and optionally comprising one or more atoms chosen from nitrogen, oxygen, and/or sulfur, and optionally substituted with at least one group chosen from —OR′, —COOR′, —COR′, —SH, —SR′, —OH, halogen atoms, and polymer residues obtainable by free-radical polymerization, polycondensation, or ring opening, and
R′ is chosen from C₁-C₁₀ alkyl groups.

11. The method of claim 9, wherein the at least one electrophilic monomer is chosen from C₁₋₂₀ polyfluoroalkyl 2-cyanoacrylates, (C₁-C₁₀ alkyl) cyanoacryclates, and (C₁-C₄ alkoxy)(C₁-C₁₀ alkyl) cyanoacrylates.

12. The method of claim 11, wherein the at least one electrophilic monomer is chosen from ethyl 2-cyanoacrylate, methyl 2-cyanoacrylate, n-propyl 2-cyanoacrylate, isopropyl 2-cyanoacrylate, tert-butyl 2-cyanoacrylate, n-butyl 2-cyanoacrylate, isobutyl 2-cyanoacrylate, 3-methoxybutyl cyanoacrylate, n-decyl cyanoacrylate, hexyl 2-cyanoacrylate, 2-ethoxyethyl 2-cyanoacrylate, 2-methoxyethyl 2-cyanoacrylate, 2-octyl 2-cyanoacrylate, 2-propoxyethyl 2-cyanoacrylate, n-octyl 2-cyanoacrylate, and isoamyl cyanoacrylate.

13. The method of claim 12, wherein the at least one electrophilic monomer is chosen from monomers of formula (V): 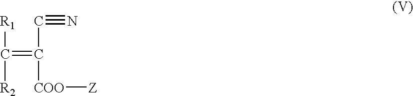
in which Z is chosen from
—(CH₂)₇—CH₃,
—CH(CH₃)—(CH₂)₅—CH₃,
—CH₂—CH(C₂H₅)—(CH₂)₃—CH₃,
—(CH₂)₅—CH(CH₃)—CH₃, and
—(CH₂)₄—CH(C₂H₅)—CH₃.

14. The method of claim 1, wherein the at least one electrophilic monomer is attached covalently to at least one support chosen from polymers, oligomers, and dendrimers.

15. The method of claim 1, wherein the at least one electrophilic monomer is present in an amount ranging from 0.001 to 80% by weight relative to the total weight of the composition.

16. The method of claim 15, wherein the at least one electrophilic monomer is present in an amount ranging from 0.1 to 40% by weight relative to the total weight of the composition.

17. The method of claim 1, wherein the cosmetically acceptable medium is anhydrous.

18. The method of claim 17, wherein the cosmetically acceptable medium is chosen from organic oils, silicones, mineral oils, vegetable oils, waxes, C₅-C₁₀ alkanes, acetone, methyl ethyl ketone, esters of C₁-C₂₀ acids, esters of C₁-C₈ alcohols, dimethoxyethane, diethoxyethane, C₁₀-C₃₀ fatty alcohols, C₁₀-C₃₀ fatty acids, C₁₀-C₃₀ fatty amides, C₁₀-C₃₀ fatty alcohol esters, and mixtures thereof.

19. The method of claim 1, wherein said film-forming composition further comprises at least one polymerization inhibitor.

20. The method of claim 19, wherein the at least one polymerization inhibitor is chosen from free-radical and/or anionic polymerization inhibitors.

21. The method of claim 19, wherein the at least one polymerization inhibitor is chosen from sulfur dioxide, nitric oxide, lactone, boron trifluoride, hydroquinone and its derivatives, benzoquinone and its derivatives, catechol and its derivatives, anisole and its derivatives, pyrogallol, 2,4-dinitrophenol, 2,4,6-trihydroxybenzene, p-methoxyphenol, hydroxybutyltoluene, alkyl sulfates, alkyl sulfites, alkyl sulfones, alkyl sulfoxides, alkyl sulfides, mercaptans, 3-sulfolene, and mixtures thereof.

22. The method of claim 19, wherein the at least one polymerization inhibitor is present in amount ranging from 10 ppm to 20% relative to the total weight of the composition.

23. The method of claim 1, wherein said film-forming composition further comprises at least one nucleophile.

24. The method of claim 23, wherein the at least one nucleophile is chosen from molecular compounds, oligomers, dendrimers, and polymers possessing nucleophilic functions chosen from R₂N⁻, NH₂⁻, Ph₃C⁻, R₃C⁻, PhNH⁻, pyridine, ArS⁻, R—C≡C⁻, RS⁻, SH⁻, RO⁻, R₂NH, ArO⁻, N₃⁻, OH⁻, ArNH₂, NH₃, I⁻, Br⁻, Cl⁻, RCOO⁻, SCN⁻, ROH, RSH, NCO⁻, CN⁻, NO₃⁻, ClO₄⁻ and H₂O, wherein Ph is a phenyl group, Ar is chosen from aryl groups, and R is chosen from C₁-C₁₀ alkyl groups.

25. The method of claim 23, wherein the at least one nucleophile is chosen from hydroxyl ions.

26. The method of claim 25, wherein the hydroxyl ions are those present in water.

27. The method of claim 1, wherein the film-forming composition further comprises at least one additional agent selected from reducing agents, fats, plasticizers, softeners, antifoams, moisturizers, pigments, clays, mineral fillers, UV filters, mineral colloids, peptizers, solubilizers, perfumes, preservatives, anionic surfactants, nonionic surfactants, amphoteric surfactants, fixative polymers, non-fixative polymers, polyols, proteins, vitamins, direct dyes, oxidation dyes, pearlizers, propellant gases, and organic or mineral thickeners.

28. The method of claim 27, wherein the at least one additional agent is encapsulated.

29. The method of claim 1, wherein the keratin materials are keratin fibers.

30. The method of claim 29, wherein the keratin fiber is hair.

31. A composition comprising, in a cosmetically acceptable medium, at least one electrophilic monomer and at least one non-silicone block copolymer chosen such that the film obtained from the composition by drying at room temperature and with a relative humidity level of about 50% has a Young's modulus ranging from 100 to 2000 MPa, measured for a thickness of 0.5 mm and with a tensile speed of 20 mm/min.

32. The composition of claim 31, wherein the at least one non-silicone block copolymer comprises water-soluble monomers of anionic, nonionic, and/or cationic nature.

33. The composition of claim 31, wherein the at least one non-silicone block copolymer comprises water-insoluble monomers chosen from vinylaromatic monomers, dienes and alkyl derivatives of dienes, chloroprene, C₁-C₁₀ alkyl acrylates, C₆-C₁₀ aryl acrylates, C₆-C₁₀ aralkyl acrylates, C₁-C₁₀ alkyl methacrylates, C₆-C₁₀ aryl methacrylates, C₆-C₁₀ aralkyl methacrylates, vinyl acetate, vinyl ethers of formula CH₂═CH—O—R″ and allylic ethers of formula CH₂═CH—CH₂—O—R″ in which R″ is chosen from C₁-C₆ alkyl groups, acrylonitrile, vinyl chloride, vinylidene chloride, caprolactone, ethylene, propylene, and vinyl monomers that are fluorinated or that comprise a perfluoro chain.

34. A method for cosmetically treating keratin materials, comprising applying a film-forming composition to the keratin materials in the presence of at least one nucleophile,
wherein the film-forming composition comprises, in a cosmetically acceptable medium, at least one electrophilic monomer and at least one non-silicone polymer chosen such that the film obtained from the composition by drying at room temperature and with a relative humidity level of about 50% has a Young's modulus ranging from 100 to 2000 MPa, measured for a thickness of 0.5 mm and with a tensile speed of 20 mm/min.

35. The method of claim 34, wherein the at least one nucleophile is chosen from molecular compounds, oligomers, dendrimers, and polymers comprising at least one nucleophilic function chosen from: R₂N₋, NH₂⁻, Ph₃C⁻, R₃C⁻, PhNH⁻, pyridine, ArS⁻, R—C≡C⁻, RS⁻, SH⁻, RO⁻, R₂NH, ArO⁻, N₃⁻, OH⁻, ArNH₂, NH₃, I⁻, Br⁻, Cl⁻, RCOO⁻, SCN⁻, ROH, RSH, NCO⁻, CN⁻, NO₃⁻, ClO₄⁻, and H₂O, wherein Ph is a phenyl group, Ar is chosen from aryl groups, and R is chosen from C₁-C₁₀ alkyl groups.

36. The method of claim 35, wherein the at least one nucleophile is a hydroxyl ion.

37. The method of claim 36, where the hydroxyl ion is present in water.

38. The method of claim 34, wherein, prior to the application of the film-forming composition, the keratin materials are wetted with an aqueous solution whose pH has been adjusted by means of a base, an acid, or an acid/base mixture.

39. The method of claim 34, wherein the keratin materials are pre-impregnated with a nucleophile other than water.

40. The method of claim 34, wherein the keratin materials are reduced before the film-forming composition is applied.

41. The method of claim 34, wherein the application of the film-forming composition is followed by rinsing.

42. A kit comprising a first composition comprising at least one electrophilic monomer and optionally at least one free-radical and/or anionic polymerization inhibitor, and a second composition comprising, in a cosmetically acceptable medium, at least one non-silicone block copolymer, such that the film obtained from combining the first and second compositions and drying at room temperature and with a relative humidity level of about 50% has a Young's modulus ranging from 100 to 2000 MPa, measured for a thickness of 0.5 mm and with a tensile speed of 20 mm/min.

43. A method for cosmetically treating keratin materials, comprising
applying to said keratin materials a composition comprising at least one non-silicone polymer, and
applying to said keratin materials a composition comprising at least one electrophilic monomer,
wherein said composition comprising at least one non-silicone polymer is applied to the keratin materials either before or after the composition comprising at least one electrophilic monomer is applied, and
such that the film obtained from combining the composition comprising at least one non-silicone polymer and the composition comprising at least one electrophilic monomer, and drying at room temperature and with a relative humidity level of about 50% has a Young's modulus ranging from 100 to 2000 MPa, measured for a thickness of 0.5 mm and with a tensile speed of 20 mm/min.
